(19) United States
(12) Patent Application Publication
(10) Pub. No.: US 2024/0247873 A1
(43) Pub. Date: Jul. 25, 2024

(54) HOLDING ELEMENT FOR A HIGH-TEMPERATURE FURNACE

(71) Applicant: PLANSEE SE, Reutte (AT)

(72) Inventors: Peter Mallaun, Reutte (AT); Dirk Handtrack, Reutte (AT); Bernd Kleinpass, Reutte (AT); Lukas Partner, Reutte (AT)

(21) Appl. No.: 18/562,431

(22) PCT Filed: May 12, 2022
(86) PCT No.: PCT/AT2022/060166

§ 371 Date: Nov. 20, 2023

(30) Foreign Application Priority Data
May 19, 2021 (AT) GM 50106/2021

(51) Int. Cl. F27D 11/02

(52) U.S. Cl. CPC F27D 11/02

(57) ABSTRACT

A ceramic holding element for a high-temperature furnace includes at least one fastening portion formed on a part of the holding element surface for mechanically connecting the holding element to a supporting structure. At least one heat conductor receiving portion on a part of the holding element surface receives a heat conductor. At least one groove is formed on a peripheral part of the surface of the holding element between the fastening portion and the heat conductor receiving portion. The groove extends substantially over the entire periphery of the peripheral part and at least one imaginary path between the fastening portion and the heat conductor receiving portion along the holding element surface crosses the groove. The groove has an aspect ratio, formed by a depth to width ratio of the groove, being greater than or equal to 1.5.

The present invention relates to a holding element for a high-temperature furnace having the features of the preamble of claim 1.

In the context of this application, high-temperature furnaces are understood to mean electrically heated furnaces which are designed for operating temperatures of greater than 600° C. In particular, the invention relates to applications at operating temperatures of greater than 800° C.

The heating of high-temperature furnaces typically takes place by passing current through heat conductors which are borne by a heat conductor mounting and which discharge heat into a processing area.

In terms of construction, this generally takes place such that a supporting structure protrudes from a shield into the processing area. The supporting structure can be configured, for example, as a bolt or as a profile. A heat conductor mounting is fastened to the supporting structure—which is also electrically connected to the shield—via an electrically insulating holding element. The one or more heat conductors are ultimately borne by the heat conductor mounting.

In the context of the present application, therefore, the purpose of a holding element is to connect a heat conductor mounting mechanically to a supporting structure and at the same time to insulate the heat conductor mounting electrically from the supporting structure. It is known to configure holding elements as ceramic sleeves which are introduced into the supporting structure.

During the operation of high-temperature furnaces, it often leads to the evaporation of the heat-treated material and as a result to the precipitation of the evaporated material. A deposit of such evaporated heat-treated material on a holding element causes a reduction in the electrical insulating function, leading to an electrical conductivity which can result in a short circuit being formed between the heat conductors and the supporting structure or the shield.

In order to remedy this problem, cleaning annealing has to be provided or contaminated holding elements have to be prematurely replaced. This results in high costs, plant stoppages and greater energy consumption.

It is the object of the present invention to specify an improved holding element. In particular, it is intended to improve the maintaining of the electrical insulating function of the holding element over the period of use of the high-temperature furnace. In particular, it is desirable if the holding element maintains its electrical insulating function even when subjected to the effects of evaporation.

The object is achieved by a holding element having the features of claim 1. Preferred developments are defined in the dependent claims.

Even with an undesirable contamination of a surface of the holding element, the electrical insulating function of the holding element is maintained by means of a holding element, comprising:
at least one fastening portion formed on a part of a surface of the holding element for mechanically attaching the holding element to a supporting structure,
at least one heat conductor receiving portion formed on a part of the surface of the holding element for receiving a heat conductor,
wherein at least one groove having a depth and a width is formed on a peripheral part of the surface of the holding element, said peripheral part being located between the fastening portion and the heat conductor receiving portion, which groove extends substantially over the entire periphery of the peripheral part of the surface and at least one imaginary path between the fastening portion and the heat conductor receiving portion along the surface of the holding element crosses at least one groove, wherein a groove has an aspect ratio, formed from the ratio of the depth to the width, of greater than or equal to 1.5.

In the holding element according to the invention a formation of a continuous electrically conductive path as a result of the deposit of electrically conductive precipitation is effectively prevented.

The groove can be implemented in different ways in terms of geometry. In terms of function, the design of the groove follows the proviso that the shape of the groove results in a shielding of a groove contour relative to a deposit of precipitation. In particular, a groove base is not subjected to any deposit. As a result, the occurrence of a continuous electrically conductive path across the groove is prevented.

The groove extending “substantially” over the entire periphery of the peripheral path of the surface is understood to mean that the groove is largely continuous.

Preferably, the groove is completely continuous, i.e. it forms a closed ring along a periphery of the holding element. The formation of a continuous electrically conductive path is prevented in a particularly effective manner by the uninterrupted design.

The “peripheral part” of the surface is understood to mean that the groove is configured on a partial surface of the surface, which partial surface forms a peripherally closed surface portion. When moving in one direction on the peripheral partial surface, the starting point is reached again. Technically speaking, the feature of the configuration of the groove on a peripheral part of the surface means that the groove can actually form an effective interruption between the fastening portion and the heat conductor receiving portion.

It is possible to conceive shapes of the holding element in which the groove is not 100% continuous, for example since a specific portion of the surface of the holding element is protected from being coated by other measures. At such points it might not be absolutely necessary for the groove to extend continuously. Thus in this context “substantially” is understood to mean that the groove extends over ≥80% of a periphery, preferably over ≥90%.

The periphery is understood to mean a distance along the surface which leads back to the starting point.

Generally, however, and preferably the groove extends completely continuously, i.e. without interruption, over the peripheral part of the surface.

Generally and preferably, the groove extends entirely on an external surface of the holding element since any deposit of precipitation primarily takes place on the external and exposed surfaces.

The fastening portion permits a mechanical attachment of the holding element to a supporting structure. The attachment can take place directly, i.e. in a direct manner, or indirectly, for example via a connecting element. The fastening portion can adopt quite different shapes. For example, it can be a surface portion of the holding element which is shaped such that it can be introduced or inserted into a corresponding receiver of a supporting structure. Alternatively or additionally, the mechanical attachment to the supporting structure can be implemented non-positively and/or positively via a connecting element. The fastening portion can thus also form a receiver for a connecting element or contain such a receiver. The supporting structure can be configured, for example, as a bolt or as a profile. It is also conceivable that the shield itself permits an attachment of the holding element, for example by the shield having an—optionally reinforced—cut-out. In this case, the shield itself functions as the supporting structure.

A part of the surface of the holding element is configured as a heat conductor receiving portion for indirectly or directly receiving a heat conductor. The heat conductor receiving portion which is different from the fastening portion is locally spaced apart from the fastening portion. In other words, the fastening portion is at least partially configured on a different region of the surface of the holding element.

An indirect or direct receiving of a heat conductor means that the heat conductor can be received via an auxiliary structure, for example a heat conductor holder, or in the case of a direct receiver, that the heat conductor receiving portion directly grips the heat conductor or a heat conductor supply line.

In particular, it is provided that the heat conductor receiving portion at least partially encompasses a heat conductor holder or a heat conductor in order to ensure a secure positioning. For example, the heat conductor receiving portion can form a through-passage for a heat conductor or a heat conductor supply line. A heat conductor supply line is understood as belonging to the heat conductor.

Preferably, it can be provided that the heat conductor receiving portion and/or the heat conductor holder permit a thermal expansion of the heat conductor holder and/or heat conductor by the provision of play.

A part of the surface of the heating element is located between the fastening portion and heat conductor receiving portion. The fastening portion and the heat conductor receiving portion are electrically separated from one another, i.e. insulated, by the interposed surface portion.

The holding element is configured such that an imaginary path between the fastening portion and the heat conductor receiving portion along the surface of the holding element crosses the at least one groove. In other words, a connection between the fastening portion and the heat conductor receiving portion along the surface is always interrupted by a groove. By this arrangement of the at least one groove it is ensured that a potential current path traverses at least one groove. This arrangement, together with the actual design of the groove, ensures an interruption in the potential current path.

To achieve the technical effect it is provided that a groove has an aspect ratio, formed by the ratio of the depth to the width, of greater than 1.5. Further preferably, the aspect ratio is greater than 3, even further preferably greater than 5. A particularly advantageous combination was found, for example, with a groove width of approximately 0.5 mm and a depth of the groove of 3 mm, which corresponds to an aspect ratio of 6.

The aspect ratio thus describes an elongation or narrowness of the groove. The greater the aspect ratio, the more effective the shielding action of the groove. Aspect ratios of greater than 10 barely provide any additional effect, since generally the groove base is no longer reached by precipitation in any case. Thus the aspect ratio is preferably ≤10.

The depth of the groove is fixed by the spacing of the groove base from the surface of the holding element. When deviating from a rectangular cross-sectional shape of the groove, a smallest width can be used as a width for determining the aspect ratio.

Preferably, the groove has a depth of at least 1 mm, whereby the groove flanks and/or a groove base are significantly shielded relative to a deposit. Potentially with a groove which is too flat, therefore, the formation of a continuous electrically conductive path is not effectively prevented.

A width of the groove is preferably at least 0.25 mm. With a groove which is too narrow, it could lead to a bridging of groove flanks by the deposit of precipitations.

It is preferably provided that a plurality of grooves, in particular two or three grooves, is configured. The configuration of a plurality of grooves is helpful for the reliable prevention of the formation of a continuous electrically conductive path.

Preferably, it is provided that a groove has a depth of between 3 mm and 10 mm. A shielding of groove flanks and/or a groove base is advantageously ensured by a depth according to this development. Greater depths do not provide any more significant shielding, but generally are more difficult to manufacture and/or structurally weaken the holding element.

Preferably, it is provided that a groove has a width of between 0.25 mm and 3 mm. The values have proved to be particularly advantageous: if the width is below 0.25 mm, it can lead to bridging across the groove flanks.

With widths of over 3 mm it can optionally lead—depending on an exposure, depth of the groove, etc.—to precipitation in the groove forming a conductive path. Widths ranging between 0.5 mm and 2 mm are even further preferred.

Preferably, it can be provided that a groove has at least in some portions an undercut, through which undercut at least in some portions a first free groove cross section with a first spacing from the surface is smaller than a second free groove cross section with a second spacing from the surface, wherein the first spacing is smaller than the second spacing. This means that in the groove a narrow point is provided at least in some portions relative to the adjoining cross section of the groove. Thus, for example, precipitation downstream of the undercut can be further reduced. “Downstream”, relative to the undercut, is understood to mean “deeper”, i.e. at positions further removed relative to the surface.

It can preferably be provided that the groove has at least in some portions a widening, through which widening a free groove cross section is enlarged at least in some portions. A wall of such a widening is particularly inaccessible to precipitation. Thus such a widening can additionally contribute to avoiding a continuous electrically conductive path.

Preferably, it can be provided that the groove has a main direction of extent which at least at one point deviates from the direction of the plane normals at the one point on the surface of the holding element at which the groove is configured. In this preferred development, this means that the groove does not run vertically but obliquely into the holding element deviating from the vertical. This provides the particular advantage that the shielding action of the groove is further improved relative to precipitation.

A design in which a groove base is no longer reached geometrically by a stream which is incident vertically into the groove is particularly advantageous.

The above-mentioned undercuts and widenings and the oblique path can be implemented in a particularly elegant manner via additive production methods.

Preferably, the holding element is configured monolithically, i.e. integrally. An integrality provides various advantages: thus a plurality of functions can be integrated in one component. An electrical insulating action is more easily predictable than, for example, with stacked arrangements of individual plates. Moreover, an assembly is facilitated.

If, for example, the holding element is formed from individual rings which are assembled to form the holding element, a dimension of the gap between the rings could change when heated up and the holding element thus could be impaired in terms of function. For maintaining the gap dimensions, a pretensioning by springs would have to be used, for example, which in the long term is problematic in the case of high-temperature applications. Accordingly, a monolithic solution is advantageous relative to the functionality and durability.

In one development, the holding element is configured as a through-passage through a shield. The holding element is designed to be inserted in or through the shield. In an installed situation, the holding element acts as an electrically insulating sleeve in the shield, wherein the shield functions as a supporting structure.

The holding element of this development permits an electrically insulated through-passage of a heating connection, i.e. an electrical supply line, through the shield. A dedicated electrical insulation of this electrical supply line can then be dispensed with.

In one embodiment of this development, the holding element is a ceramic sleeve, for example a hollow cylinder, wherein a groove is configured on at least one of the front faces thereof, as discussed above.

Preferably, the holding element consists of a high-temperature-resistant ceramic. In particular, technical ceramics such as for example aluminum oxide (Al₂O₃), zirconium oxide (ZrO₂), silicon oxide (SiO₂), silicon nitride (Si₃N₄) and mixtures of technical ceramics are suitable. “Consist” is to be understood to mean here that the relevant proportion is formed by the corresponding ceramic. Further preferably, the holding element consists of ≥98% of the respective technical ceramic or a mixture of technical ceramics. The usual impurities can be present.

Preferably, the holding element consists entirely of the respective ceramic. In the case of aluminum oxide having a purity of greater than or equal to 99.7%, particularly high operating temperatures are possible and a good electrical insulating action can be achieved.

Preferably, the holding element is implemented via an additive production method. The manufacture via an additive production method is particularly advantageous for smaller quantities and/or when producing complex shapes and also permits, in particular, a plurality of functions to be combined in one component.

The grooves can be implemented by cutting out material and do not have to be incorporated by grinding—as in conventional production methods. This also permits further degrees of freedom in the design of the grooves, such as the aforementioned undercuts and constrictions.

In particular, the invention is suitable for a metallic high-temperature furnace.

In the case of a metallic high-temperature furnace, an insulation of a processing area relative to a furnace shell substantially consists of metal. Such metallic high-temperature furnaces generally have a so-called radiation shield which is formed from metal plates, which are arranged substantially parallel to one another and spaced apart from one another via spacer means, and which consist of refractory metal, in particular tungsten, molybdenum or the alloys thereof. In the context of the present invention, refractory metals are understood to mean the metals of group 4 (titanium, zirconium and hafnium), group 5 (vanadium, niobium, tantalum) and group 6 (chromium, molybdenum, tungsten) of the periodic table and rhenium. Refractory metal alloys are understood to mean alloys having at least 50% of the relevant element. These materials have, amongst other things, an excellent dimensional stability at high operating temperatures.

Metallic high-temperature furnaces permit particularly clean furnace atmospheres to be set, which is not always possible with ceramic or graphite furnaces. Moreover, in particular, they are suitable for heat treatments under vacuum, since no outgassing and/or porous surfaces are present.

The holding element according to the invention assists the technical possibilities of metallic high-temperature furnaces and improves the economic efficiency thereof.

Protection is also sought for a method for manufacturing a holding element of the invention.

In the case of complex geometries and/or small quantities, the manufacturing preferably takes place via an additive production method.

Binder-based additive production methods, in particular, have proved advantageous. This includes filament printing which is particularly preferred.

For forming the groove, no material is deposited at the locations of the subsequent groove, or a temporary spacer, for example a binder without powder, can be deposited.

For larger quantities, the manufacture via powder injection molding (PIM) is advantageous. In the case of ceramic powders, as in the present case, this is generally called ceramic injection molding (CIM). A ceramic powder with a binder is processed to form a plasticizable mass which can be processed as in plastics injection molding. The green body obtained is debound and sintered. The groove can be reproduced by the molding tool. Moreover, it is naturally possible to incorporate the grooves mechanically. This can be carried out in a green state or in a sintered state of the holding element.

Further advantages and expediencies of the invention are found in the following description of exemplary embodiments, with reference to the accompanying figures. In the figures:

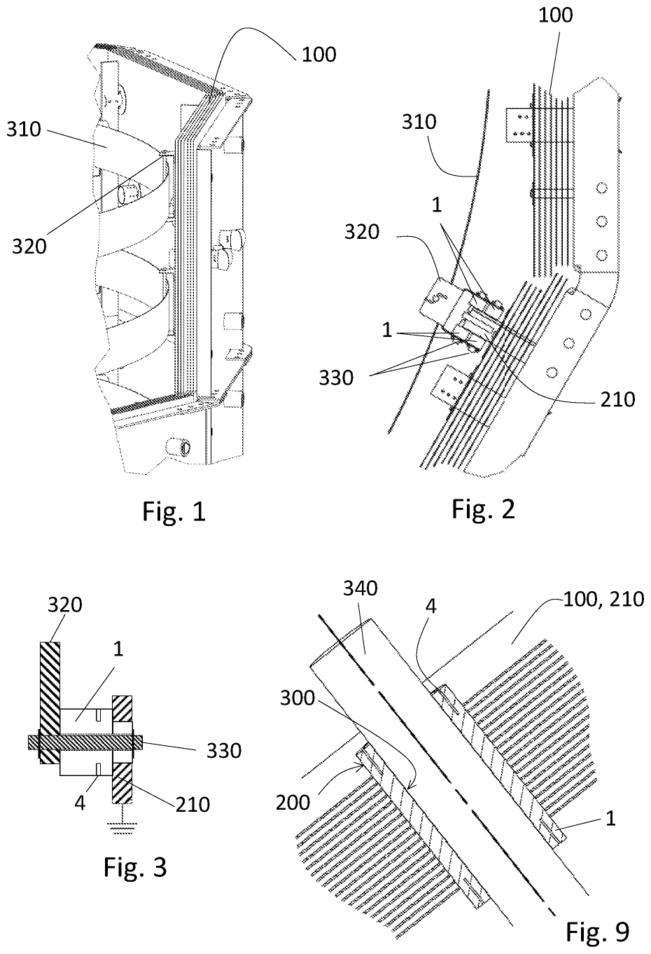

FIG. 1: shows a detail of a metallic high-temperature furnace

FIG. 2: shows a detail of the shield and heat conductor mounting

FIG. 3 shows a holding element in a first exemplary embodiment

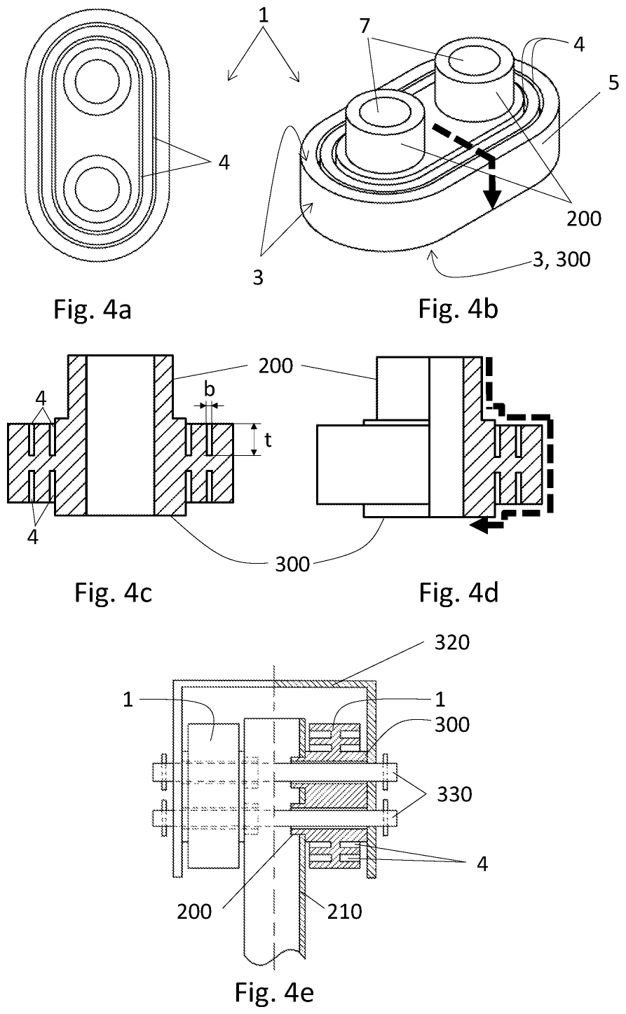

FIGS. 4a-4e show a holding element in a next exemplary embodiment

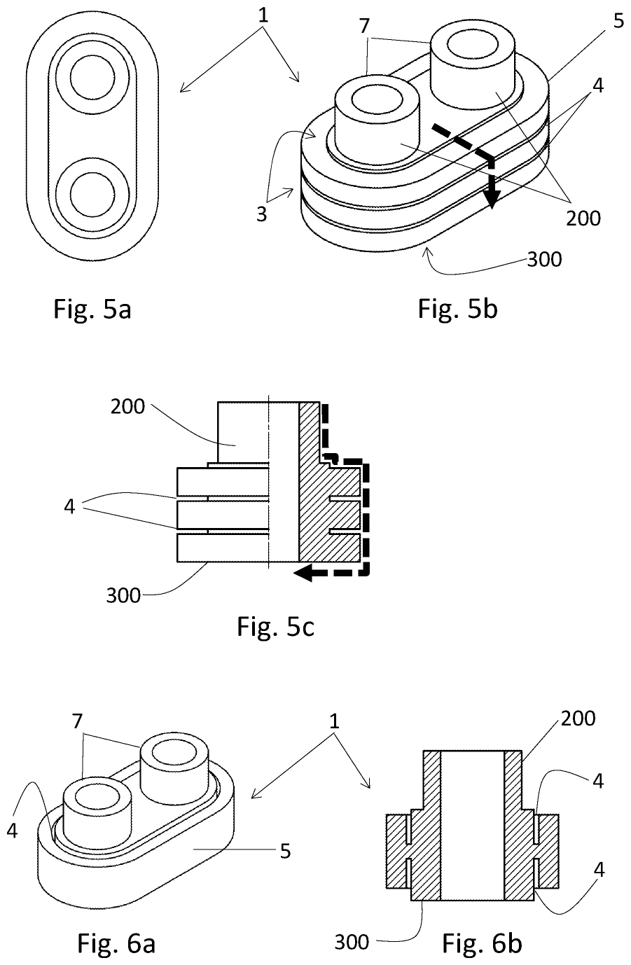

FIGS. 5a-5c show a holding element in a further exemplary embodiment

FIGS. 6a-6b show a holding element in a further exemplary embodiment

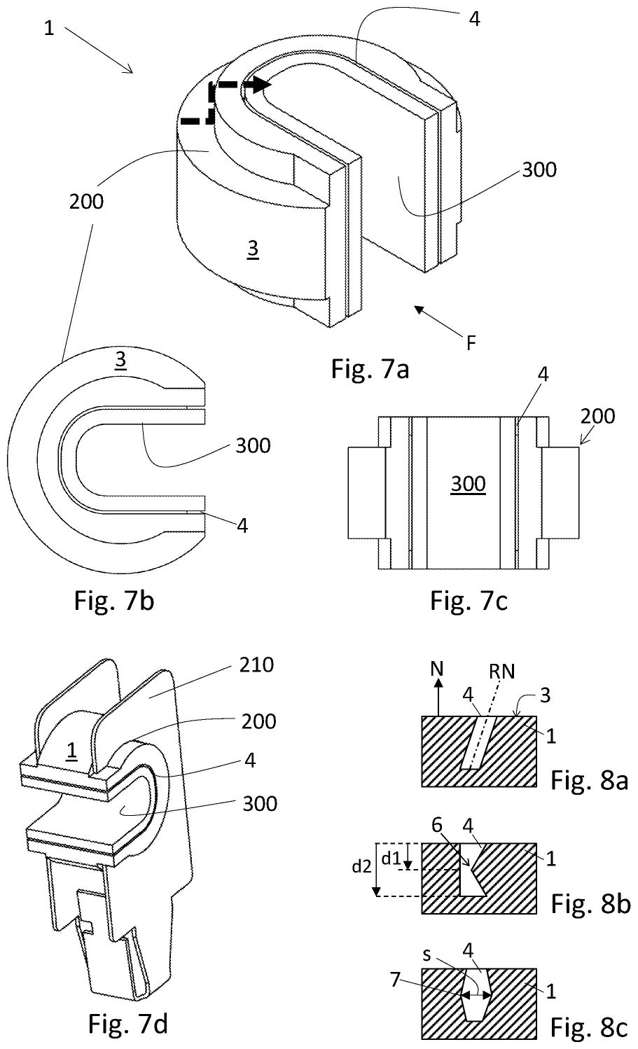

FIGS. 7a-7d show a holding element in a further exemplary embodiment

FIGS. 8a-8c show particular embodiments of grooves

FIG. 9 shows a holding element in a further exemplary embodiment

FIG. 1 shows, for orientation, schematically and in detail a typical shield 100 of a metallic high-temperature furnace. The shield 100 is formed from a stack of spaced-apart metal plates. In particular, the metal plates consist of refractory metal. In the view shown, a processing area which continues to the left is insulated by the shield 100 relative to a cooled furnace shell (to the right, not shown). A heat conductor 310 is borne by heat conductor mountings 320. The heat conductor mountings 320 are designed here as brackets which hold a strip-shaped heat conductor 310 in position. The specific design of the shield, heat conductor and heat conductor mountings can vary.

FIG. 2 shows in a plan view the circumstances of a heat conductor mounting 320. A supporting structure 210 is guided through the shield 100. The supporting structure 210 can be designed, for example, as a profile rail or as a tube. The supporting structure 210 has the task of mechanically holding a heat conductor 310, optionally by means of a heat conductor mounting 320. The supporting structure 210, a furnace shell (not shown) and the shield 100 are connected together conductively, thus they are at the same electrical potential, generally earthed (to the ground).

The heating of the furnace takes place by means of heat conductors 310 by electrical resistance heating. To this end, the heat conductor 310 has to be electrically insulated from the supporting structure 210. This electrical decoupling takes place by holding elements 1 which in the example shown are designed as ceramic sleeves. The ceramic sleeves (in the present example four pieces, in each case two per side) protrude in some portions into the supporting structure 210 and are held in position by inserted bolts 330. At the ends of the bolts 330, securing means such as snap rings or cotter pins fix the assembly. Due to the holding elements 1, the inserted bolts 330 remain spaced apart from the supporting structure 210 and are insulated thereby.

A drawback with the known solutions is that due to contamination, for example evaporation of the heat-treated material, it can lead to the formation of conductive paths on the holding elements, which ultimately can cause a short circuit between the heat conductor 310 or heat conductor mounting 320 and the supporting structure 210.

The risk of the formation of a conductive coating is not only present by an evaporation of metals due to high vapor pressure (for example copper) but also by thermo-chemical transport processes (for example by local oxidation→transport of the oxide gas→local reduction) and sputter effects with arcing (for example with incorrect charging).

FIG. 3 shows in a schematic sketch a holding element 1 according to the invention in a first exemplary embodiment by which the above-mentioned problems can be remedied. FIG. 3 shows a cross section along the longitudinal axis of the holding element 1, which is cylindrical here, and the bolt 330 running therein.

The mechanical fastening of the heat conductor mounting 320 to the supporting structure 210 takes place via the insulating holding element 1. It can be identified that the bolt 330 is spaced apart from the supporting structure 210, and thus is electrically insulated, by a projection which is configured on the holding element 1 and which protrudes into the supporting structure 210. A peripheral groove 4 which prevents the production of a continuous electrically conductive path between the supporting structure 210 and the heat conductor mounting 320 is configured on the cylindrical holding element 1.

FIGS. 4a to 4e show different views of a holding element 1 according to the invention in a next exemplary embodiment. FIG. 4a shows a plan view, FIG. 4b shows a perspective view, FIG. 4c shows a full view, FIG. 4d shows a half section. The half section means that half of the drawing shows a cross section of the relevant component and the other image half shows an unsectioned view.

In the holding element 1 of the present exemplary embodiment the fastening portion 200 is configured in the form of two sleeve-shaped projections on a part of a surface 3. The fastening portion 200 permits an insertion into a supporting structure 210 as shown in FIG. 4e. The sections of FIGS. 4c and 4d are placed in each case centrally, i.e. along a diameter, through the sleeve-shaped projections 7. According to this exemplary embodiment, the holding element 1 has a base body 5 with two sleeve-shaped projections 7 which, for example, can be introduced into a supporting structure 210. In this exemplary embodiment, a mechanical connection is possible with a supporting structure 210, for example, via bolts which can be inserted through the holding element 1 and a supporting structure 210. In order to remain within the specific example of the fastening, the aforementioned bolt is then separated by a sleeve-shaped projection 7 from a supporting structure 210 and thereby electrically insulated therefrom.

A heat conductor receiving portion 300 is located spaced apart from the fastening portion 200 for indirectly or directly receiving a heat conductor (not shown here). The heat conductor receiving portion 300 is a front face of the holding element 1 facing away from the fastening portion 200. In the present example, two grooves 4 which run in parallel are designed on a front face of the holding element 1 facing the fastening portion 200 and facing the heat conductor receiving portion 300. The grooves 4 are peripheral and closed in each case.

Thus the situation is provided that at least one groove 4 which extends over the entire periphery of the surface 3 is configured on a peripheral part of the surface 3 of the holding element 1 located between the fastening portion 200 and the heat conductor receiving portion 300.

As visible from the view of FIG. 4b, in the context of this disclosure a “periphery” along the surface 3 is not necessarily understood to mean the longest path along the surface 3. Rather, in this exemplary embodiment grooves run on a front face of the holding element 1 facing the fastening portion 200 and a further pair of grooves 4 runs on a front face of the holding element 1 facing the heat conductor receiving portion 300.

From the view in FIG. 4c the width—b—and depth—t—of the groove 4 are emphasized. An aspect ratio formed from the ratio of the depth—t—to the width—b—is greater than or equal to 1.5, in the present exemplary embodiment the aspect ratio is, for example, 6. The aspect ratio provides a measure of the elongation of the groove 4 and thus a measure of the effectiveness of the groove 4 to prevent a deposit of precipitation on a groove contour, in particular on a groove base. With an aspect ratio of greater than or equal to 1.5, the occurrence of a continuous electrically conductive path along the groove contour is prevented. Thus an uncoated surface always remains present and thus a conductive path is not formed across the groove 4.

The grooves 4 are designed equally here. Naturally with a plurality of grooves 4, they could differ from one another. Moreover, it is not absolutely necessary that a groove 4 is designed to be the same along its entire extent. For example, a cross-sectional shape along the extent of a groove 4 could vary.

The cross-sectional shape of the grooves 4 in this exemplary embodiment is rectangular. The depth—t—is measured from the surface 3 to the groove base. With a deviation from the rectangular shape, expediently a narrowest width of the groove 4 is used as the width—b—since the narrowest point is relevant for a shielding action of the groove.

In one development, the grooves 4 can also run obliquely to the surface, which optionally further improves a shielding action of the groove 4.

In FIGS. 4b and 4d an imaginary path between the fastening portion 200 and the heat conductor receiving portion 300 along the surface 3 is illustrated with a block arrow. As can be seen, the grooves 4 are arranged such that the imaginary path crosses the grooves 4. Thus it is ensured that a continuous electrical connection is not present between the fastening portion 200 and the heat conductor receiving portion 300. In this exemplary embodiment, it is provided that grooves 4 are configured on a front surface facing the fastening portion 200 and grooves 4 are configured on a front surface facing the heat conductor receiving portion 300. As a result, the imaginary path between the fastening portion 200 and the heat conductor receiving portion 300 has to traverse a pair of grooves 4 twice, which further improves an action of the holding element 1 relative to electrical breakdown.

FIG. 4e shows an assembly situation with two holding elements 1 according to the discussed exemplary embodiment in a half section. The holding elements 1 protrude in some portions into the supporting structure 210 and are held in position by inserted bolts 330. At the ends of the bolts 330, securing means such as snap rings or cotter pins fix the assembly. Due to the holding elements 1, the inserted bolts 330 remain spaced apart from the supporting structure 210 and are insulated thereby. A heat conductor mounting 320—in this case bracket-shaped—is mounted on the heat conductor receiving portion 300 of the holding element 1. As can be derived from the view, an imaginary path between the fastening portion 200 and heat conductor receiving portion 300 traverses the grooves 4.

The arrangement and the design of the grooves 4 prevents any deposit of a conductive precipitation on the holding element 1 leading to the formation of a continuous electrically conductive path.

FIGS. 5a to 5c show a holding element in a different exemplary embodiment. In FIG. 5a a plan view is shown, in FIG. 5b a perspective view is shown and in FIG. 5c a half section is shown. There is no repetition of recurring reference signs. In contrast to the exemplary embodiment of FIGS. 4a-e, here the grooves 4 are integrally formed on a lateral surface of the base body 5 of the holding element 1. The peripheral part of the surface 3 located between the fastening portion 200 and the heat conductor receiving portion 300 is thus the lateral surface of the base body 5 of the holding element 1.

As visualized in FIG. 5c via a block arrow, the imaginary path between the fastening portion 200 and heat conductor receiving portion 300 also has to traverse the grooves 4, whereby the holding element 1 counteracts an electrical breakdown in the case of any coating due to precipitation. Thus an effective separation of the fastening portion 200 and heat conductor receiving portion 300 is provided by the groove 4.

FIGS. 6a and 6b show an exemplary embodiment with in each case a groove 4 on the front faces of the base body 5.

Naturally, combinations are also possible regarding the arrangement of the grooves 4, i.e. a configuration of grooves 4 on the front surfaces and lateral surfaces.

FIGS. 7a and 7d show views of a holding element 1 according to a further exemplary embodiment.

FIG. 7a shows a perspective view, FIG. 7b shows a plan view, FIG. 7c shows a front view, as is produced along the front viewing direction—F—illustrated in FIG. 7a. FIG. 7d shows the holding element 1 in an assembly with a supporting structure 210.

The holding element 1 in this exemplary embodiment is designed as a type of C-shaped clamp. The fastening portion 200 is configured on a surface at the back of the C-shape. A supporting structure can have, for example, recesses corresponding thereto so that the holding element 1 can be inserted or clipped into the supporting structure. Remaining with the image of the C-shape, the opening of the C-shape forms the heat conductor receiving portion 300. For example, a heat conductor or heat conductor mounting can be directly inserted in the heat conductor receiving portion 300. It is frequently the case that the heat conductor receiving portion 300 permits a certain play for compensating for the thermal expansion of the heat conductor or heat conductor mounting. Thus the holding element 1 particularly advantageously fulfills a plurality of functions in an integrated component. It is also the case here that a peripheral surface portion can be defined between the fastening portion 200 and the heat conductor receiving portion 300, a groove 4 being configured on the peripheral part of the surface. An imaginary path between the fastening portion 200 and the heat conductor receiving portion 300 along the surface 3 of the holding element 1 crosses the at least one groove 4, whereby a short circuit due to any deposits is prevented.

FIG. 7d shows a perspective view of the holding element 1 in the assembly with the supporting structure 210. The supporting structure 210 is configured as a clip with two limbs into which the holding element 1 can be inserted or clipped. In this exemplary embodiment, the fastening portion 200 forms a bearing surface and a stop for the supporting structure 210. The opening of the holding element 1 forms the heat conductor receiving portion 300. It can be identified that the peripheral groove 4 is located between the supporting structure 210 and the heat conductor receiving portion 300.

FIG. 9 shows a further exemplary embodiment in a sectional and perspective view. Here the holding element 1 is configured as a through-passage through a shield 100. In the exemplary embodiment, the holding element 1 is configured to be inserted into or through the shield 100. In an installed situation, the holding element 1 acts as an electrically insulating sleeve in the shield 100, wherein the shield 100 acts at the same time as a supporting structure 210.

The holding element 1 of this development permits an electrically insulated through-passage of a heating connection 340, i.e. an electrical supply line through the shield. A dedicated electrical insulation of this electrical supply line can then be dispensed with.

A heat conductor (not shown) is supplied with current by the heating connection 340. Thus the inner surface of the holding element 1 of this exemplary embodiment is to be referred to as a heat conductor receiving portion 300 for indirectly receiving a heat conductor.

The exemplary embodiments, which are clearly different visually, show that the invention is not limited to a single design of holding element.

Preferably and as shown in the discussed exemplary embodiments, the holding element is configured monolithically, i.e. integrally.

FIG. 8a shows schematically a groove 4 which has a main direction of extent—RN—which deviates on at least one point from the direction of the plane normals—N—at that one point on the surface 3 of the holding element 1 at which the groove 4 is configured. In other words, the groove 4 runs obliquely to the surface 3. A shielding action of the groove 4 can be further improved by this design.

FIG. 8b shows schematically a holding element with a groove 4 such that the groove 4 has at least in some portions an undercut 6, through which undercut 6 at least in some portions a first free groove cross section with a first spacing d1 to the surface 3 is smaller than a second free groove cross section with a second spacing d2 to the surface, wherein d1<d2. A shielding of the groove base can be further improved by an undercut 6 since barely any precipitation occurs on the other side of the undercut 6.

A groove 4 which has in some portions a widening 7 is shown in FIG. 8c, through which widening 7 a free groove cross section s is enlarged at least in some portions. In particular, precipitation on the walls of the groove 4 can be reduced by a widening 7.

1-15. (canceled)

16. A holding element made of ceramic for a high-temperature furnace, the holding element comprising:
a surface of the holding element, said surface having a peripheral part with a periphery;
at least one fastening portion formed on a part of said surface of the holding element for mechanically connecting the holding element to a supporting structure;
at least one heat conductor receiving portion formed on a part of said surface of the holding element for receiving a heat conductor;
said peripheral part being located between said fastening portion and said heat conductor receiving portion;
said peripheral part of said surface having at least one groove formed thereon having a depth and a width;
said groove extending substantially entirely over said periphery of said peripheral part of said surface and defining at least one imaginary path between said fastening portion and said heat conductor receiving portion along said surface of the holding element crossing said at least one groove; and
said at least one groove having an aspect ratio, formed by a ratio of said depth to said width, of greater than or equal to 1.5.

17. The holding element according to claim 16, wherein said at least one groove is a plurality of grooves.

18. The holding element according to claim 16, wherein said at least one groove includes two or three grooves.

19. The holding element according to claim 16, wherein said depth of said at least one groove is between 3 mm and 10 mm.

20. The holding element according to claim 16, wherein said width of said at least one groove is between 0.25 mm and 3 mm.

21. The holding element according to claim 16, wherein:
said at least one groove has an undercut in at least some portions;
said undercut, at least in some portions, defines a first free groove cross section disposed at a first spacing from the surface of the holding element and a second free groove cross section disposed at a second spacing from the surface of the holding element; and
said first spacing is smaller than second spacing.

22. The holding element according to claim 16, wherein said at least one groove has a widening at least in some portions, and said widening defines a free groove cross section being enlarged at least in some portions.

23. The holding element according to claim 16, wherein said at least one groove is formed at a point along the surface of the holding element, and said at least one groove has a main direction of extent deviating at least at said point from a direction of a plane normal.

24. The holding element according to claim 16, wherein the holding element is configured monolithically.

25. The holding element according to claim 16, wherein the holding element is configured as a through-passage through a shield.

26. The holding element according to claim 16, wherein the holding element is formed of a binder-based material.

27. The holding element according to claim 16, wherein the holding element is formed of an additive material.

28. The holding element according to claim 26, wherein the material is a powder-injection-molded material.

29. A high-temperature furnace, comprising at least one holding element according to claim 16.

30. A method for manufacturing a holding element, the method comprising using a binder-based production method to manufacture the holding element according to claim 16.

31. The method for manufacturing a holding element according to claim 30, which further comprises selecting the binder-based production method from a group of production methods including filament printing and powder injection molding.
